(19) United States
(12) Patent Application Publication
(10) Pub. No.: US 2006/0097553 A1
(43) Pub. Date: May 11, 2006

(54) Airplane seating module system

(76) Inventors: David Spurlock, Greenwich, CT (US); R. Steven Justice, Tyrone, GA (US)

Correspondence Address: SQUIRE, SANDERS & DEMPSEY L.L.P, 600 HANSEN WAY, PALO ALTO, CA, 94304-1043, US

(21) Appl. No.: 11/221,449

(22) Filed: Sep. 7, 2005

Related U.S. Application Data
(60) Provisional application No. 60/618,621, filed on Oct. 13, 2004.

(51) Int. Cl. B64D 11/06; A47C 15/00

(52) U.S. Cl. 297/248; 244/118.6

(57) ABSTRACT

Embodiments of a seating module system are described. In one embodiment, a seating module may include a central keel defining opposite aisle and window side areas and opposite fore and aft ends. The seating module may also have an aisle seat and an aisle footstool located in the aisle side area. The seating module may further include a window seat and a window footstool located in the window side area. The window seat may be in a staggered relationship with the aisle seat with the window seat positioned closer towards the fore end than the aisle seat. The seating module may also include a privacy screen that comprises an window seat portion and an aisle seat portion. The window seat portion of the privacy screen may extend along the central keel and between the window seat and the window footstool. The aisle seat portion of the privacy screen may extend between the window seat and the window footstool between the window seat portion of the privacy screen, and also extend along the central keel between the window footstool and the aisle seat, and further extend behind the aisle seat and along an aisle side of the aisle seat in a direction towards the fore end.

### CROSS REFERENCE TO RELATED APPLICATION

This application claims the benefit of U.S. Provisional Application No. 60/618,621, filed Oct. 13, 2004 entitled “Seat design and pattern” and which is incorporated by reference herein.

### TECHNICAL FIELD

Embodiments described herein may relate generally to seating arrangements and more particularly to seating arrangements for a passenger cabin or compartment of a vehicle.

### BACKGROUND

A common consideration in aircraft passenger seat design is to produce a seat module that provides an excellent passenger experience. In long distance trips (also known as long haul trips), a passenger can spend a substantial amount of time sitting in his or her seat. Many such long haul passengers are executives that are frequently willing to pay additional amounts of money to obtain enhanced comfort during their trips by sitting in larger and more comfortable first and business class seats. In order to encourage more of this high end travel, airlines and other commercial transportation companies are continually attempt to develop ways of improving the comfort and convenience of passengers as part of their overall operations.

### SUMMARY

Embodiments of a seating module system are described. In one embodiment, a seating module may include a central keel defining opposite aisle and window side areas and opposite fore and aft ends. The seating module may also have an aisle seat and an aisle footstool located in the aisle side area. The seating module may further include a window seat and a window footstool located in the window side area. The window seat may be in a staggered relationship with the aisle seat with the window seat positioned closer towards the fore end than the aisle seat. The seating module may also include a privacy screen that comprises an window seat portion and an aisle seat portion. The window seat portion of the privacy screen may extend along the central keel and between the window seat and the window footstool. The aisle seat portion of the privacy screen may extend between the window seat and the window footstool between the window seat portion of the privacy screen, and also extend along the central keel between the window footstool and the aisle seat, and further extend behind the aisle seat and along an aisle side of the aisle seat in a direction towards the fore end.

In accordance with one embodiment, the system module system may comprise a plurality of seating modules with each seating module having an aisle seat located behind an aisle footstool and a window seat located in front of a window footstool, the window seat in a staggered arrangement with the aisle seat with the window seat more forwardly positioned than the aisle seat. In such an embodiment, the plurality of seating modules may be arranged in at least one row with adjacent seating modules spaced apart from each other. In such an arrangement, the window footstool of a first seating module may be positioned facing the window seat of an adjacent second seating module so that the window footstool of the first seating module and the window seat of the second seating module together may define a window passenger section.

### BRIEF DESCRIPTION OF THE DRAWINGS

FIG. 1 is a schematic diagram of an exemplary layout of a seating module system in a passenger cabin of an airplane in accordance with an illustrative embodiment;

FIG. 2 is a schematic diagram of a second exemplary layout of a seating module system in a passenger cabin of an airplane in accordance with an second illustrative embodiment;

FIG. 3 is a schematic front view of a seating module system in a transverse cross section of a passenger cabin of an airplane in accordance with an exemplary embodiment;

FIG. 4 is a schematic front perspective view of an aisle side of a seating module in accordance with one embodiment;

FIG. 5 is a schematic front perspective view of a window side of the seating module embodiment shown in FIG. 4;

FIG. 6 is a schematic rear perspective view of the window side of the seating module embodiment shown in FIG. 4;

FIG. 7 is a schematic side view of the aisle side of the seating module embodiment shown in FIG. 4;

FIG. 8 is a schematic front view of the seating module embodiment shown in FIG. 4;

FIG. 9 is a schematic top view of the seating module embodiment shown in FIG. 4;

FIG. 10 is a schematic front perspective view of an aisle side of two seating modules arranged in a row in accordance with a second embodiment;

FIG. 11 is a schematic front perspective view of a window side of the two seating modules of the embodiment shown in FIG. 10;

FIG. 12 is a schematic rear perspective view of the aisle side of the two seating modules of the embodiment shown in FIG. 10;

FIG. 13 is a schematic rear perspective view of the window side of the two seating modules of the embodiment shown in FIG. 10;

FIG. 14 is a schematic side view of the aisle side of the two seating modules of the embodiment shown in FIG. 10;

FIG. 15 is a schematic side view of the window side of the two seating modules of the embodiment shown in FIG. 10;

FIG. 16 is a schematic front view of the seating module embodiment shown in FIG. 10;

FIG. 17 is a schematic back view of the seating module embodiment shown in FIG. 10; and

FIG. 18 is a schematic top view of the two seating modules of the embodiment shown in FIG. 10.

### DETAILED DESCRIPTION

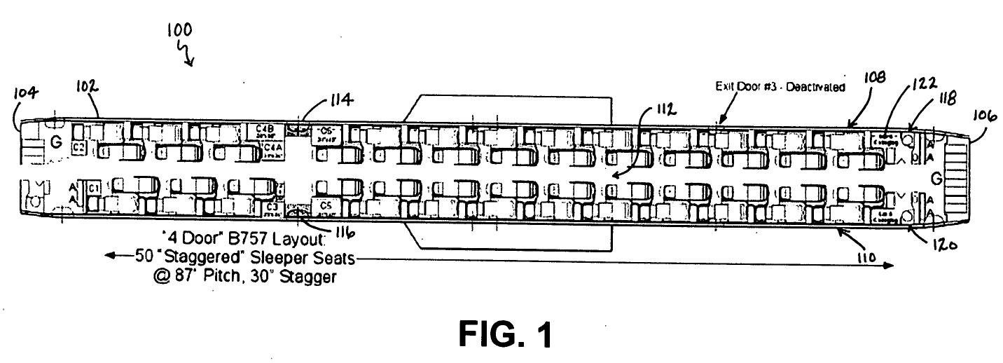

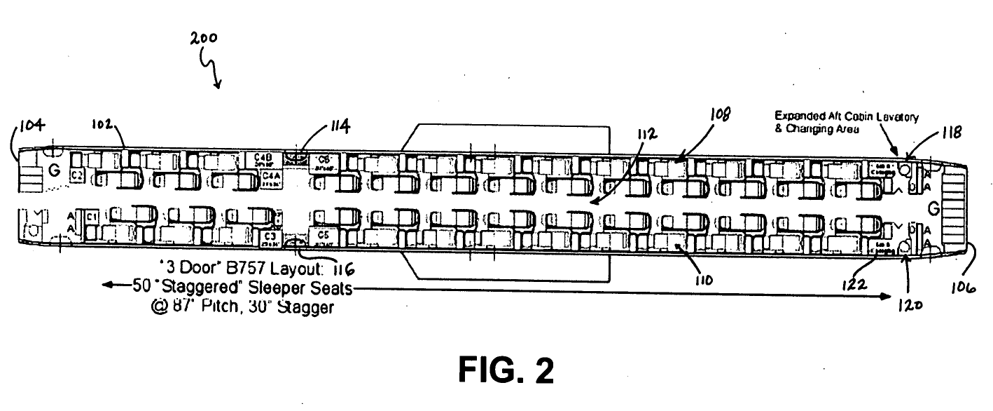

FIGS. 1 and 2 illustrate two illustrative layouts 100, 200 (also referred to a layouts of passenger accommodations or LOPAs) of embodiments of a seating module system in an airplane passenger cabin 102 (also referred to as a passenger compartment). While the exemplary embodiments set forth herein are described in the context of an illustrative airplane implementation, it should be understood that embodiments of may be implemented in other vehicles including, for example, railway cars and buses.

The passenger cabin 102 may have front and back ends 104, 106 (also referred to as fore and aft ends or the nose and tail ends) and left and right sides (also referred to as port and starboard sides). Typically, the left and right sides of the passenger cabin may have a plurality of windows and, as a result, both sides may be also referred to as window sides of the passenger cabin.

The passenger cabin 102 may contain a plurality of seating modules arranged, for example, in one or more rows. As shown in the embodiments depicted in FIGS. 1 and 2, the passenger cabin 102 may include two rows 108, 110 of seating modules with one along each window side of the passenger cabin 102. The rows 108, 110 may be spaced apart so that an aisle 112 may extend between them from the front 104 to the back 106 of the passenger cabin 102. In such an arrangement, each of the seating modules may be described as having window and aisle sides with the window side of each seating module located next to the adjacent window side of the passenger cabin and the aisle side of each module located adjacent the aisle of the passenger cabin.

The particular illustrative passenger cabins depicted in FIGS. 1 and 2 are based on a Boeing 757-200 aircraft (also referred to as the B757-200). The Boeing 757-200 aircrafts presently are manufactured with two different passenger cabins configurations: a configuration where each window side of the passenger side has three doors (also referred to as the three-door configuration) and another configuration where each window side of the passenger side has four doors (also referred to as the four-door configuration). FIG. 1 depicts the four-door configuration while FIG. 2 depicts the three-door configuration. The B757-200 three door configuration interior layout can provide seating for up to 50 passengers. In the four-door configuration, the layout may require that the door located aft of the wing (referred to as door number three) be left unblocked and, as a result, can reduce the total number of seats to 48. Each layout leaves the forward mid-fuselage doors of the passenger cabin available for passenger loading.

In an illustrative embodiment of the seating module system implemented in a Boeing 757-200 aircraft, the following exemplary features may be implemented. With respect to total passenger accommodations and seat pitch, in one exemplary embodiment, 50 passenger seats may be provided in a one-class layout using seating modules having a staggered double seating arrangement at an approximate 87″ pitch. Seats may also convert to flat bed configuration with unrestricted access to main aisle by all seats.

Flight attendant seating may be provided in the passenger cabin for up to six flight attendants. For example, seating for up to six flight attendants may be provided in the forward (door two) and aft (door four) door areas. Flight Attendant seating may also be provided at or near the other doors as required for certification. In FIGS. 1 and 2, the flight attendant seats are represented by the letter “A.”

The standard Boeing 757-200 aircraft has six Type 1 doors (e.g., two forward, two mid-fuselage, and two aft) and four over wing Type 2 emergency exits. In one implementation, the Type 1 doors 114, 116 may be left clear and available for passenger loading and unloading. The over-wing Type 2 exits may be blocked and even rendered inoperable while still meeting applicable FAA requirements due to the reduced number of passenger accommodations. As an option, if access can be provided in the layout to all or some of the window exits, then those exits may be retained to provide additional egress capability.

The layout may also include lavatories 118, 120 in the passenger cabin. In one implementation, adequate lavatory facilities may be provided that are capable of handling lavatory use for 50 passengers during an eight-hour flight. Expanding the size of some or all of the lavatories (as compared to the standard-sized lavatories found in Boeing 757-200 aircraft) may also be desirable to provide addition space (e.g., changing area space 122) to permit passengers to change clothes in the lavatory while in-flight. For example, the aft lavatories in the passenger cabin may be increased in size from a standard-sized lavatory by about 15″-20″ along the longitudinal axis of the passenger cabin 102 to allow for the design of a combined lavatory/changing area.

The passenger cabin 102 may also include adequate facilities (i.e., galleys) for providing food and refreshments for 50 passengers during an eight-hour flight. Galleys are indicated in FIGS. 1 and 2 by the letter “G.”

In one implementation, in-cabin storage may include common storage closets or bins may be provided for storing one standard carry on bag (e.g., average dimensions of 14″×9″×22″) per passenger. The in-cabin storage bins may be located near the loading doors to allow quick storage of carry-on bags by the flight attendants as the passengers enter the cabin (in some implementations, passengers may also be able to store carry on luggage at their seats). The locations of in-cabin storage areas in the illustrative layouts shown in FIGS. 1 and 2 are represented by the alphanumerics that start with the letter “C.”

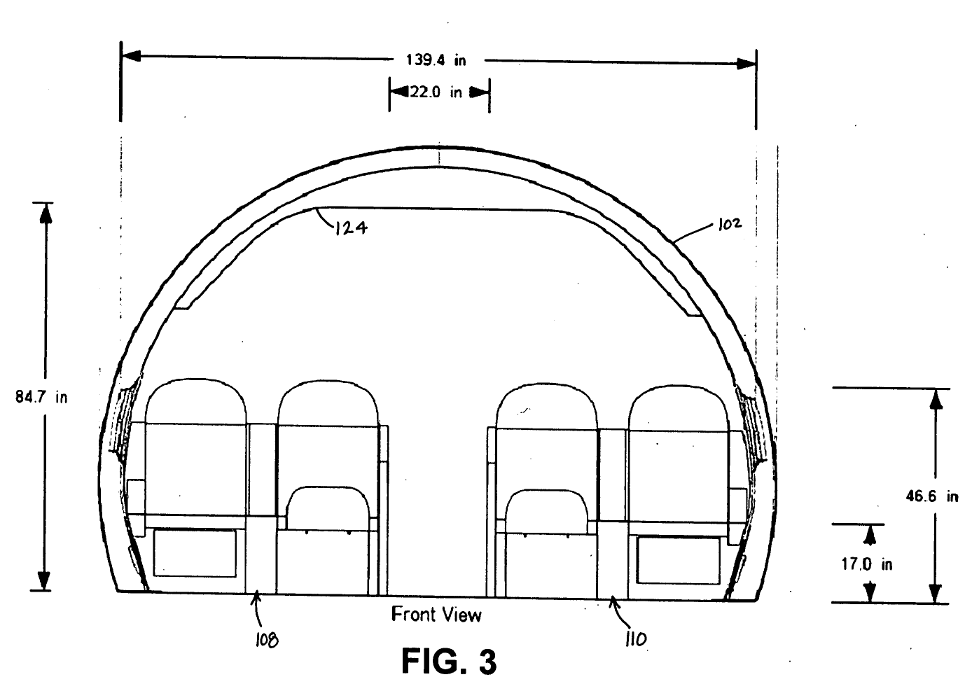

As an option, the overhead storage bins that are typically provided in a passenger compartment 102 of an airplane can be removed to provide a more spacious cabin environment as shown in FIG. 3. In replacement of the overhead storage bins, filler panels 124 may be provided above the sidewalls and coupled to the headliner panels. The filler panels 124 may be manufactured using materials and designs similar to that used for the sidewalls of the passenger cabin 102. The filler panels 124 may also display graphics and be colored in a manner that helps to reinforce trademarks and brand identification of a given airline.

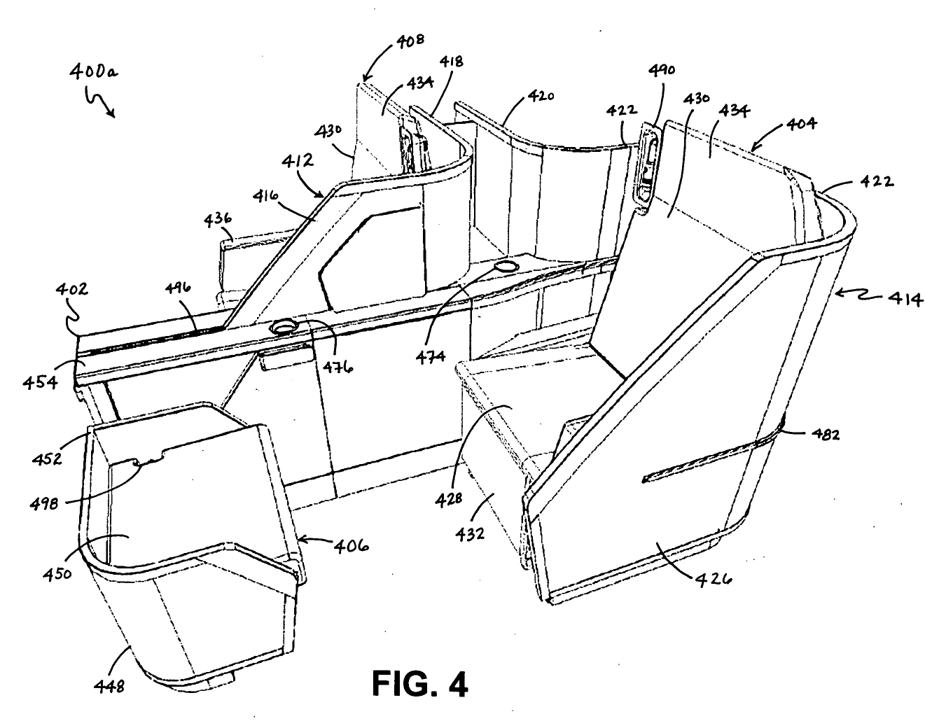

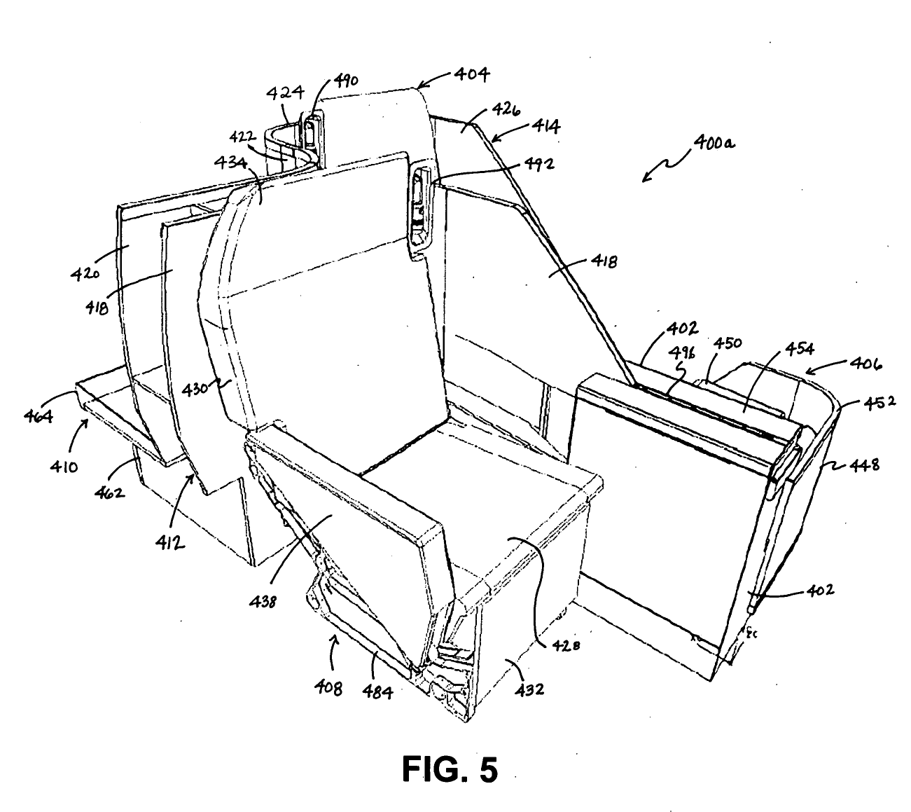

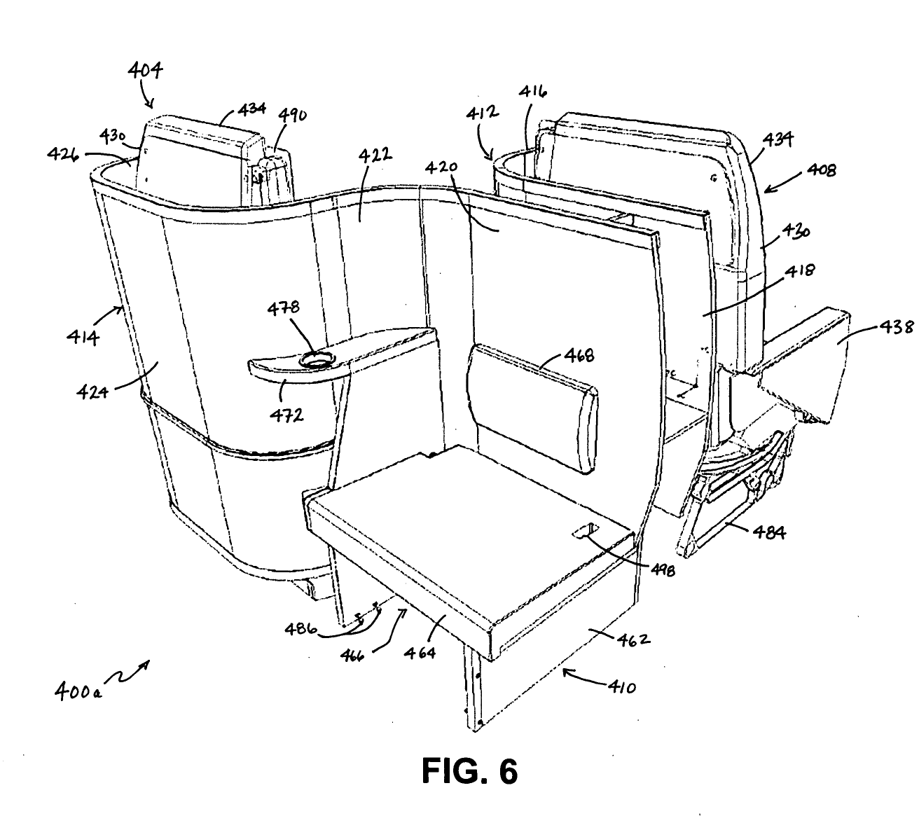

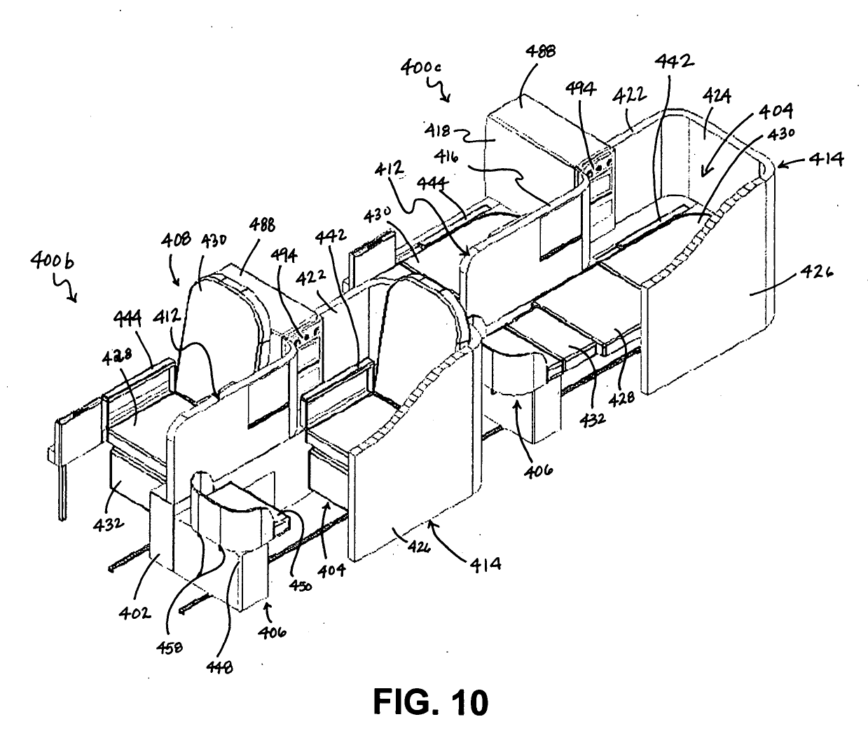

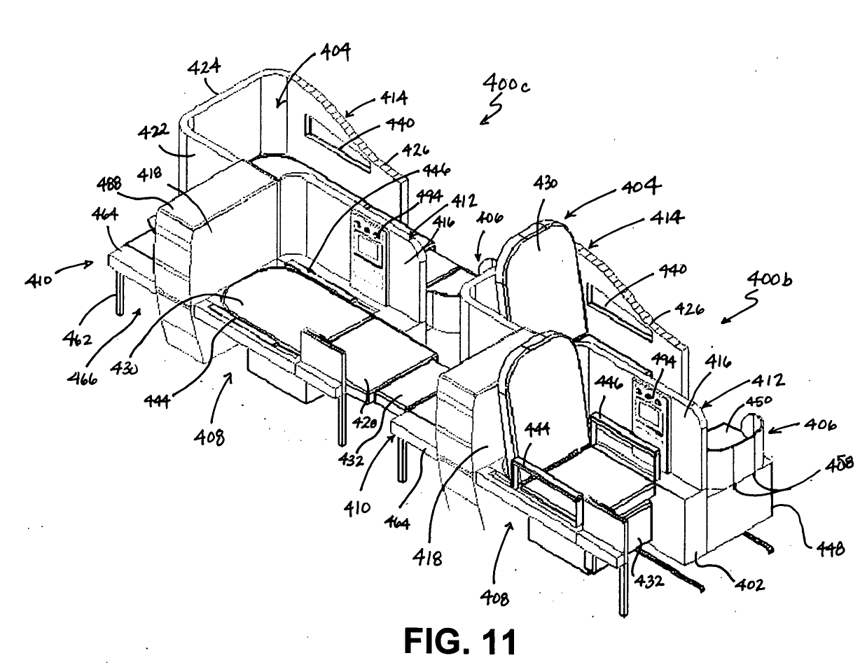

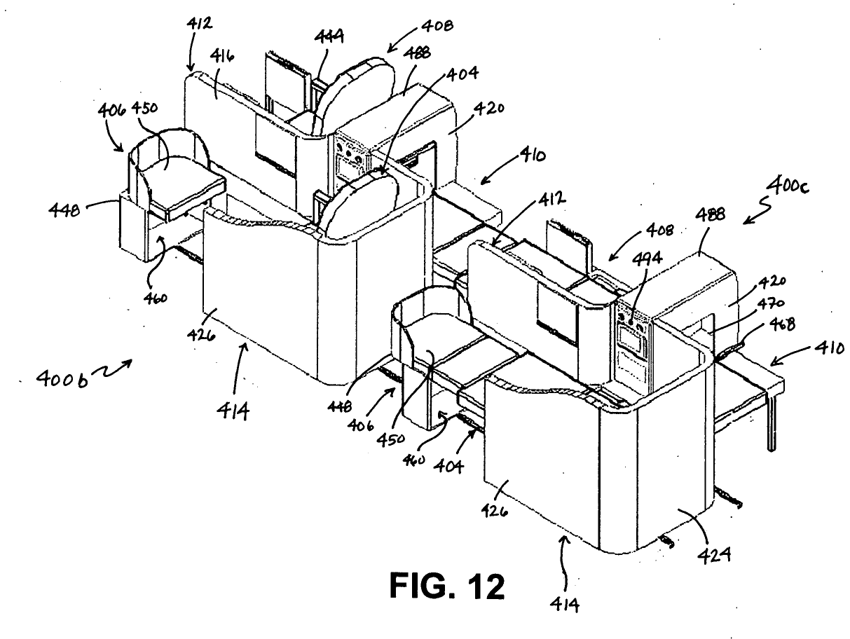

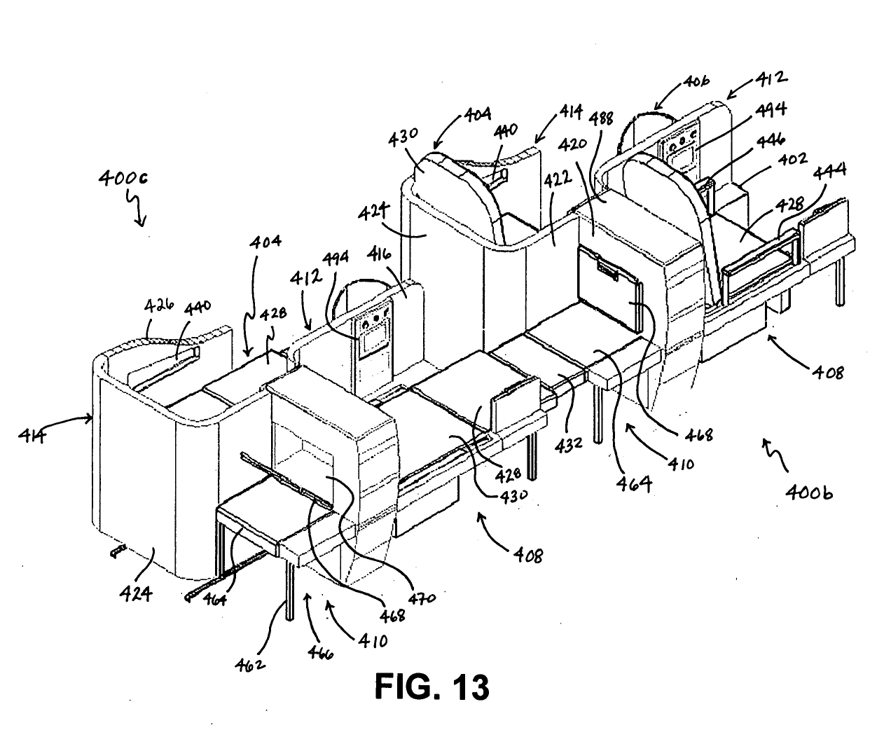

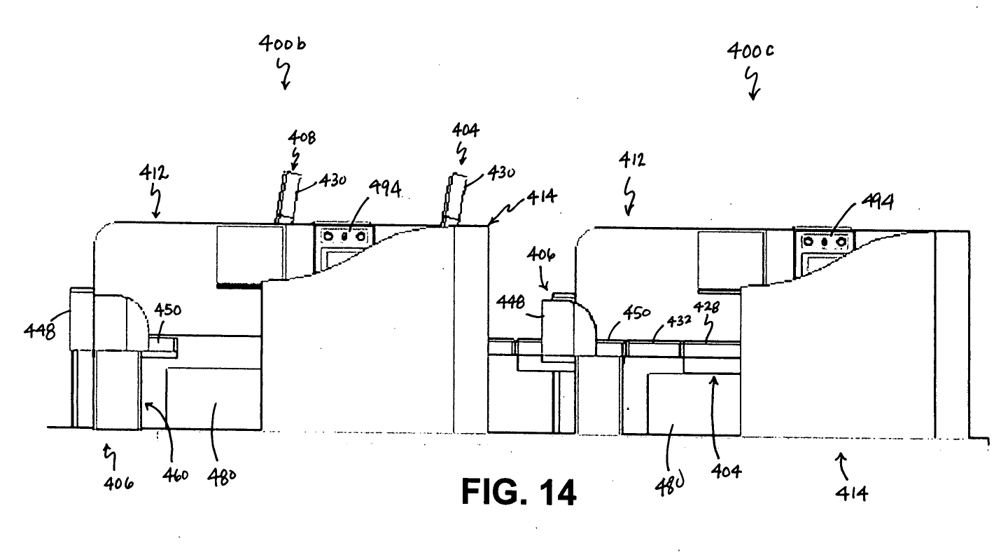

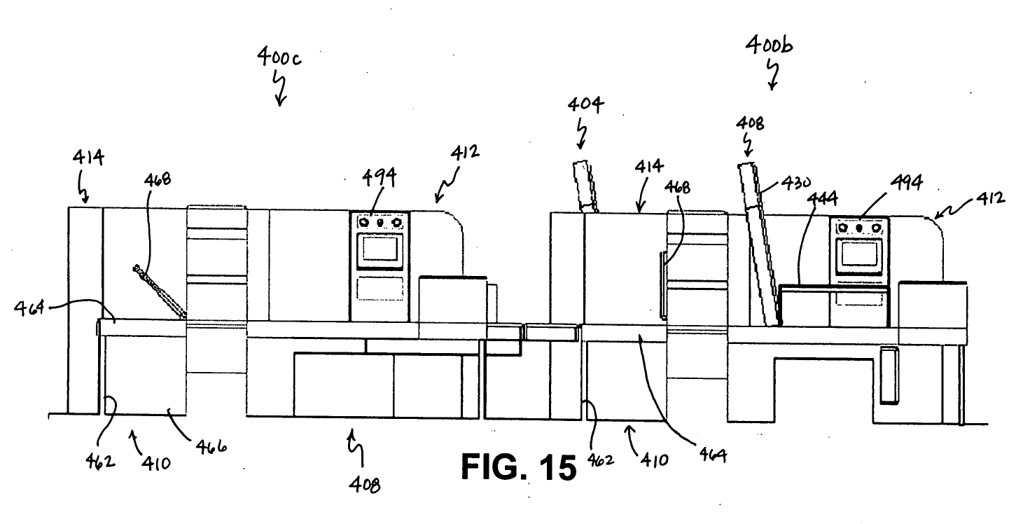

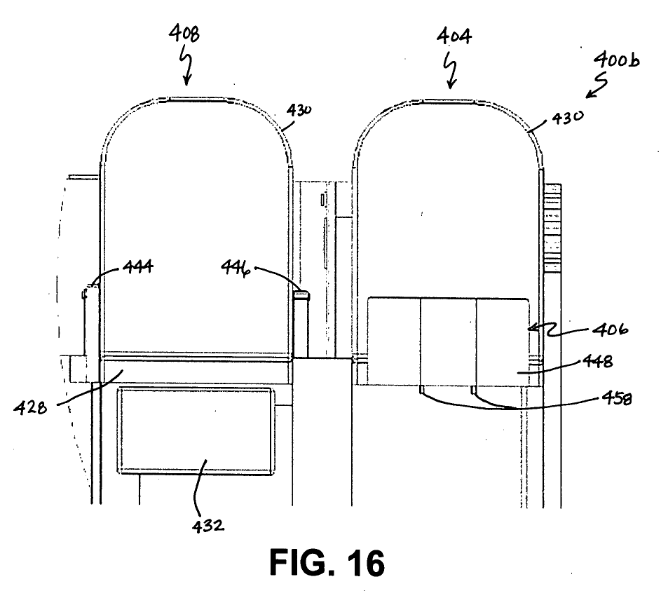

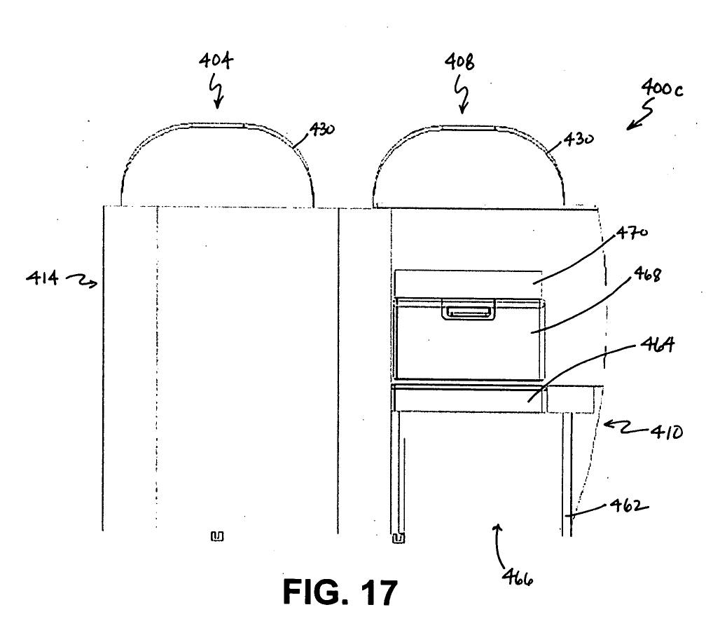

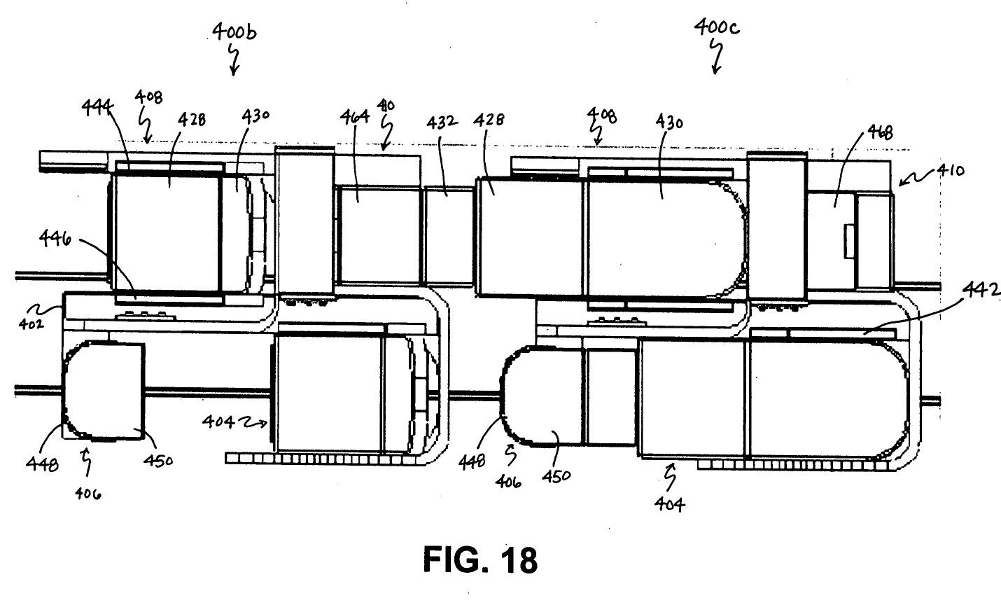

FIGS. 4-9 schematically illustrate one embodiment of a seating module 400a while FIG. 10-18 schematically illustrate two seating modules 400b, 400c of another embodiment arranged in a row. Both of these embodiments may be utilized for implementing the seating module layouts shown in FIGS. 1 and 2. It should be understood to one of ordinary skill in the art that some or all of the elements described for the embodiment depicted in FIGS. 4-9 may be included in the embodiment depicted in FIGS. 10-18 and vice versa.

In general, a seating module 400a, 400b, 400c may include a central keel 402 that defines opposite aisle and window side areas and opposite fore (or nose) and aft (or tail) ends of the seating module. A seating module 400a, 400b, 400c also may include an aisle seat 404 and an aisle footstool 406 on the aisle side area of the seating module. The aisle seat 404 may be positioned towards the aft end of the seating module while the aisle footstool 406 may be positioned towards the fore end of the seating module and spaced apart from the aisle seat 404. A seat module 400a, 400b, 400c may further include a window seat 408 and a window footstool 410 on the window side area of the seating module. The window footstool 410 may be positioned towards the aft end of the seating module and the window seat 408 may be positioned between fore end of the seating module and the window footstool 410. The window seat 408 may also be located adjacent a space defined on the aisle side area of the seating module between the aisle seat 404 and aisle footstool 406 so that the window seat 408 is in a staggered relationship with the aisle seat 404 with the window seat 408 positioned closer towards the fore end of the seating module than the aisle seat 404.

A seating module 400a, 400b, 400c may further include a privacy screen that comprises an window seat portion 412 and an aisle seat portion 414. The window seat portion 412 of the privacy screen may include a central section 416 that extends along a central portion of the central keel 402 and an aft section 418 that extends between the window seat 408 and the window footstool 410. The aisle seat portion 414 of the privacy screen may comprise a fore section 420, a central section 422, an aft section 424 and an aisle section 426. The fore section 420 may extend between the window seat 408 and the window footstool 410 behind the window seat portion 412 of the privacy screen. The central section 422 may extend along an aft portion of the central keel 402 between the window footstool 410 and the aisle seat 404. The aft section 424 may extend behind the aisle seat 404. The aisle section 426 may extend along an aisle side of the aisle seat 404 opposite the central keel side of the aisle seat 404 in a forwardly direction towards the fore end of the seating module.

The aisle and window seats 404, 408 of a seating module 400a, 400b, 400c may each comprise a reclining seat having a seat portion 428 (or sitting portion), a reclining back 430, and a retractable leg rest 432. As depicted in the embodiment shown in FIGS. 4-9, the reclining backs of the aisle and window seats may also have an angled or inclined headrest portion 434.

Each seat 404, 408 may be selectively positionable between an upright position and a reclined position. When a seat 404, 408 is positioned towards the reclined position from the upright position, the back 430 of the seat may recline or pivot downwards as the seat portion 428 of the seat moves laterally forwards. When a seat 404, 408 is fully positioned in the reclined position, the seat portion 428 and back 430 of the seat may lie in a generally common horizontal plane.

The leg rest 432 of a seat 404, 408 may be selectively positionable between a retracted position and an extended position. When positioned towards the extended position from the retracted position, the leg rest 432 may extend or pivot upwards. When the leg rest 432 is positioned in the extended position, the seat portion 428 and leg rest 432 of the seat may lie in a generally common horizontal plane. In use, a seat 404, 408 may be converted into a bed by positioning the seat in the reclined position and extending its leg rest of the seat into the extended position.

A seat 404, 408 may also include an electromechanical system for moving the seat 404, 408 between the upright and reclined positions. An interface may also be provided to permit a passenger to control the operation of the electromechanical system. A manual back-up system for the electro-mechanical system may also be provide in case of electrical system failure during flight to permit passengers to manually position their seats in a reclined or upright position.

The aisle and window seats 404, 408 may each have one or two armrests (e.g., armrests 436, 438, 440, 442, 444, 446) that may be implemented as either a retractable armrest or a fixed armrest. For example, one or both of the armrests of a seat can be retractably mounted to the corresponding seat to permit selective positioning of the armrest(s) between raised and lowered positions (e.g., armrests 442, 444 and 446 of the embodiment of the seating module shown in FIGS. 10-18). In such an embodiment, a top surface of an armrest may lie in a common plane with a top face of the seat portion of the seat when the armrest is positioned in the lowered positioned (see, e.g., the retractable armrests of the aft-positioned seating module 400c in FIGS. 10-18) and lie in plane above the top face of the seat portion when the armrest is positioned in the raised position (see, e.g., the armrests of the aft-positioned seating module 400c in FIGS. 10-18). In one embodiment, the retractable armrest of an aisle seat may be located adjacent the aisle side of the aisle seat. In another embodiment, the retractable armrest of the window seat may be located adjacent the window side of the window seat. In a further embodiment, the retractable armrest of the window seat may be located adjacent the window side of the window seat. In one embodiment, an armrest of the aisle seat 404 (e.g., armrest 440 in the embodiment depicted in FIGS. 10-18) may be formed from an integrated portion of an privacy screen adjacent the aisle side of the aisle seat (such as, e.g., the aisle section 426 of the aisle seat portion 414 of the privacy screen).

The aisle footstool 406 of a seating module may comprise a frame 448 and a seat portion 450 that may be coupled to the frame 448. In one embodiment, the frame 448 of the aisle footstool 406 may have an upper edge 452 that defines a plane beneath an upper face 454 of the central keel 402 so that the upper profile of the aisle footstool 406 is lower than that of the central keel 402. This may be useful to help, in certain embodiments, to suggest a more open (i.e., less compartmentalized) layout is desired.

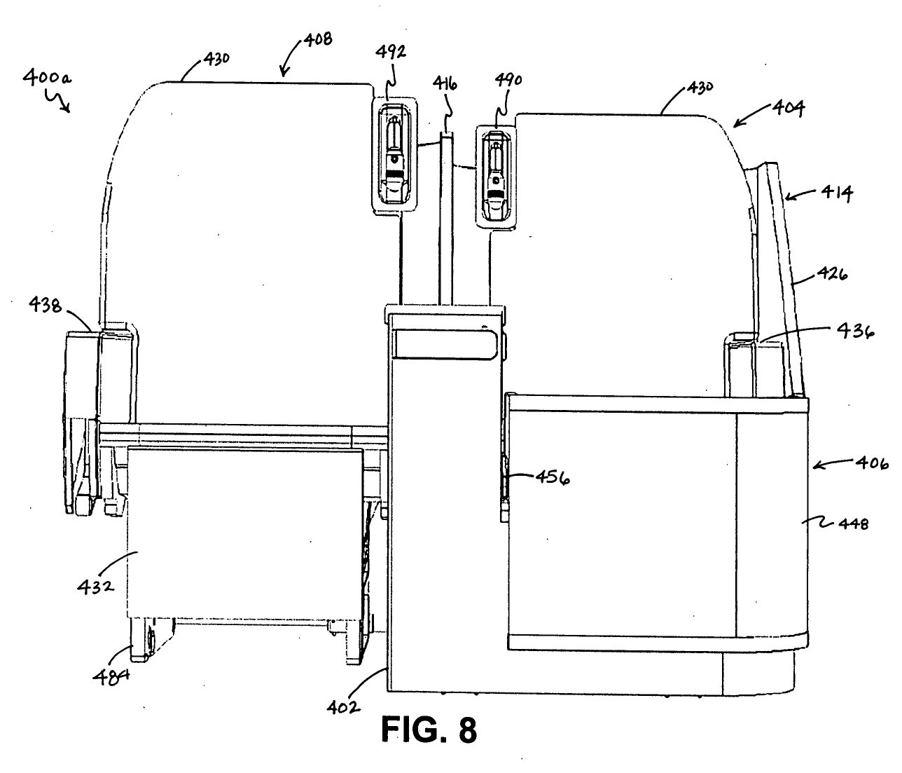

In one embodiment, an aisle footstool 406 may be movably or slidably coupled to the central keel 402 (see e.g., FIG. 8) and/or another portion of the seating module to permit selective traverse movement of the aisle footstool 406 between fore and aft positions. In another embodiment, the seat portion 450 of an aisle footstool 406 may be movably or slidably coupled to the frame 448 (see e.g., FIG. 10) to permit selective traverse movement of the aisle footstool between fore and aft positions. The slidable coupling of the seat portion of the aisle footstool to the frame of the aisle footstool may be accomplished by some sort of sliding mounting fixtures that may incorporate one or more sliding track and rail fixtures (e.g., sliding mounting fixtures 456, 458).

In use, the space between the aisle footstool 406 and the aisle seat 404 when the aisle footstool 406 is positioned in the fore position may be greater in length (i.e., longer) than when the aisle footstool 406 is positioned in the aft position. When the aisle footstool 406 is positioned in the fore position, a back portion of the frame 448 of the aisle footstool may forwardly extend beyond the fore end of the central keel. When the aisle footstool positioned in the aft position, the back portion of the frame 448 of the aisle footstool may be located so that it is flush with or behind the fore end of the central keel 402. In one embodiment, the aisle footstool 406 may further include a releasable locking mechanism to selectively hold the aisle footstool in a fixed position.

An aisle footstool 406 may include a lower storage space 460 for stowing a passenger's carry on baggage. The lower storage space 460 may be located in or defined by the frame 448 of the aisle footstool 406 beneath the seat portion 450 of the aisle footstool 406. To provide easier access to the storage space 460, an embodiment of the seat portion 450 of the aisle footstool 406 may be implemented so that it is pivotally coupled to the frame 448 of the aisle footstool 406 to permit selective pivoting of the seat portion 450 of the aisle footstool 406 between horizontal lowered position and a raised position where the end of the seat portion 450 of aisle footstool 406 is pivoted in an upwards direction to further expose the lower storage space 460. In one embodiment, when the positioned in the raised position, the seat portion 450 of the aisle footstool 406 may even be positioned in a substantially vertical alignment with a top face of the seat portion 450 being located adjacent the back position of the frame 448. When positioned in the lowered position, the seat portion 450 of the aisle footstool 406 may be positioned in a substantially horizontal alignment with the top face of the seat portion 450 being located in a common generally horizontal plane with a top face of the seat portion 428 of the aisle seat 404 (taking into account any contouring that may be formed in the top faces of the seat portions of the aisle seat and/or aisle footstool).

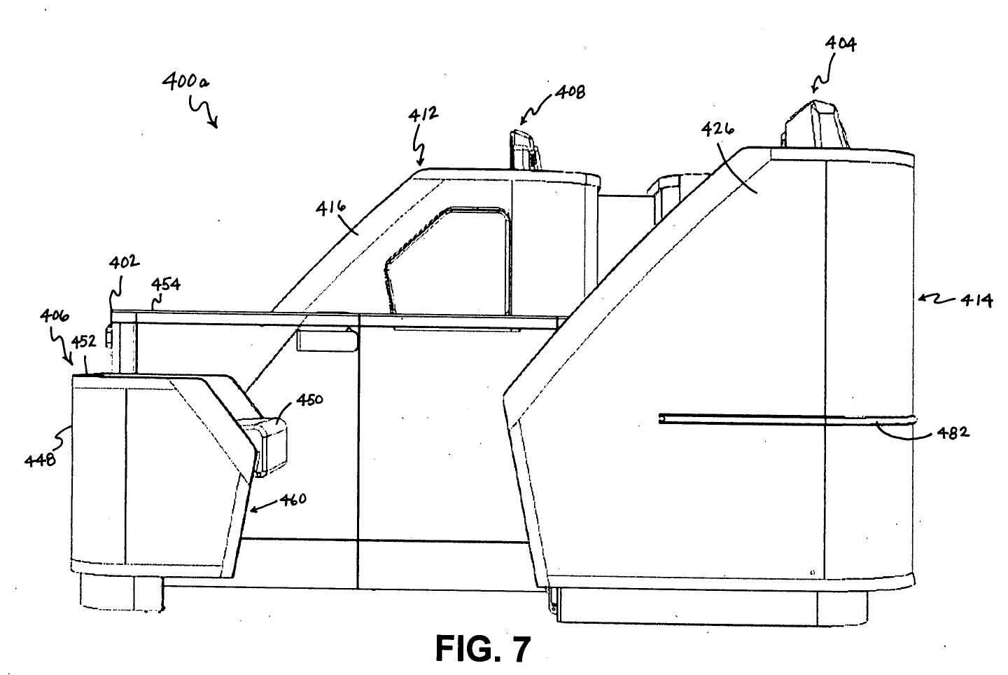

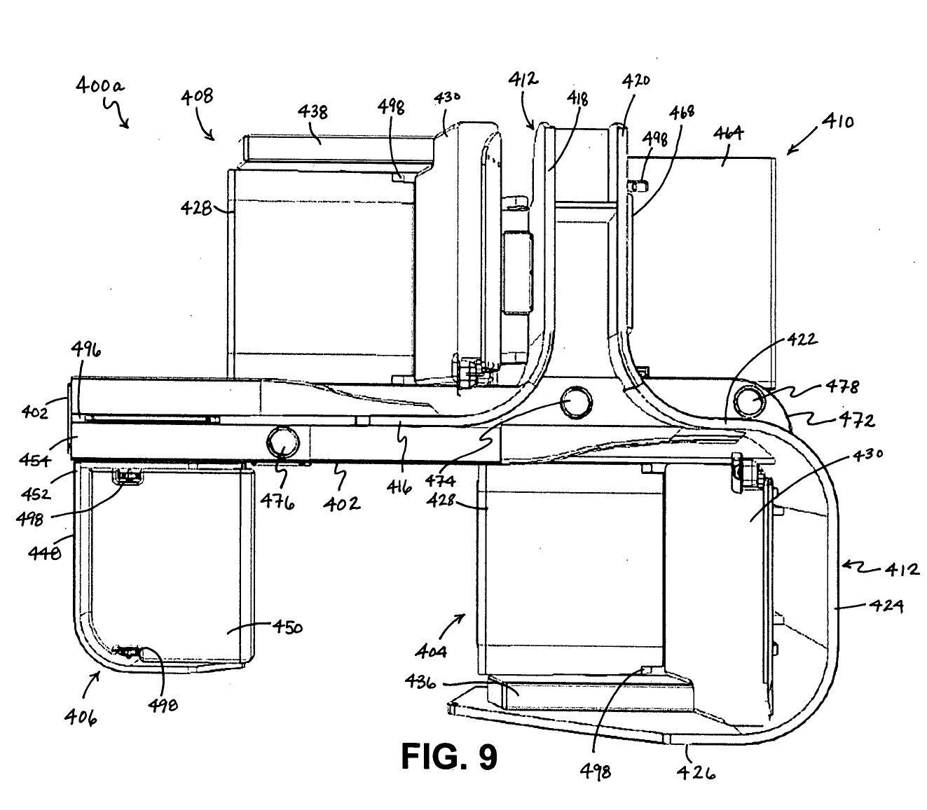

Illustrative fore positions for the aisle footstool 406 may be seen, for example in FIG. 7 for the seating module embodiment 400a depicted in FIGS. 4-9 and the aft seating module 400c in FIGS. 10, 14 and 18 for the seating module embodiment depicted in FIG. 10-18. Illustrative aft positions for the aisle footstool 406 may be seen, for example in FIG. 9 for the seating module embodiment 400a depicted in FIGS. 4-9 and the front seating module 400b in FIGS. 10, 11, 14 and 18 for the seating module embodiment depicted in FIG. 10-18.

Like the aisle footstool 406, the window footstool 410 of a seating module 400a, 400b, 400c may comprise a frame 462 and a seat portion 464 that may be coupled to the frame of the window footstool. The window footstool 410 may also have a lower storage space 466 defined by the frame 462 of the window footstool 410 and located beneath the seat portion 464 of the window footstool 410. Like the aisle footstool 406, the seat portion 464 of a window footstool 410 may also be pivotally coupled to the frame 462 of the window footstool 410 to permit selective pivoting of the seat portion 464 between raised and lower positions with respect to the frame 462. In one embodiment, when positioned in the raised position, the seat portion 464 of the window footstool 410 may be orientated in a substantially vertical alignment so that a top face of the seat portion 464 is located adjacent the fore section 420 of the aisle seat portion 414 of the privacy screen. When positioned in the lowered position, the seat portion 464 of the window footstool 410 may be orientated in a substantially horizontal alignment.

For added comfort, a back pad 468 may be provided for the window footstool 410. The back pad 468 may be to the fore section 420 of the aisle seat portion 414 of the privacy screen above the seat portion 464 of the window footstool 410. As shown in the embodiment depicted in FIGS. 10-18, the back pad 468 may being pivotally coupled to the fore section 420 of the aisle seat portion 414 of the privacy screen and serve as a cover or door to a storage or access space 470.

As shown in the embodiment illustrated in FIGS. 4-9, a window footstool armrest 472 may also be provided for the window footstool 410. The window footstool armrest 472 may be positioned adjacent a central keel side of the window footstool 419. The window footstool armrest 472 can be secured in a variety of ways. For example, the window footstool armrest 472 may be coupled to the central keel 402, an adjacent region of the aisle seat portion 414 of the privacy screen, the frame 462 and/or seat portion 464 of window footstool 410. As another option, the window footstool armrest 472 may be formed in a portion of an upper face of the central keel 402 that is located at the aft end of the central keel.

As illustrated in the embodiment 400a shown in FIGS. 4-9, a seating module may include a plurality of cup holders 474, 476, 478. In one such embodiment, at least a portion of the cup holders may be formed in the upper face of the central keel. For example, sockets may be formed in the central keel that are configured for receiving a cup or some other container therein. The cup holders may include, for example, an aisle seat cup holder 474 located adjacent the aisle seat 404, an aisle footstool cup holder 476 located adjacent the aisle footstool 406, and/or a window footstool cup holder 478 adjacent the window footstool 410.

As shown in the embodiment illustrated in FIGS. 10-18, the central keel 402 may also have a storage compartment or cabinet 480 therein extending underneath the window seat 408 and have an opening in the aisle side of the central keel 402 that may be covered by a door or other cover that may be, for example, pivotally coupled to the aisle side of the central keel.

As an option, guard rail 482 may be provided on the aisle seat portion 414 of the privacy screen to protect the exterior surface of the aisle seat portion 414 of the privacy screen from wear and tear. As shown in FIGS. 4, 6 and 7, the guard rail 482 may be extended in a generally horizontal orientation at an elevation approximately the same as the top surface of the seat portion 428 of the aisle seat 404.

In one embodiment, the privacy screen may be at least 20″ higher than the level of a seat when in a reclined position. For the aisle seats 404, it may also be desirable that the privacy screen extend to at least the front of the seat cushion when upright. However, the contours of the privacy screen may be adjusted to suit any desired aesthetics.

In one embodiment, a seating module 400a, 400b, 400c may have mountings or some sort of undercarriage for mounting the seat module to slotted floor tracks in a passenger cabin 102. Such a mounting may include, for example, a pair of leg rails (e.g., such as leg rail 484) for each seat 404, 408 located beneath the seat portion of the corresponding seat, and fasteners (e.g., fastener 486) for coupling the frame of the footstools to the floor tracks (or rails) provided in the passenger cabin 102. In another embodiment, the seating module may include some sort of pallet mounting for securing the seating module to the passenger cabin. U.S. Pat. No. 4,936,527 to F. J. Gorges entitled “Movable Seating System for Aircraft” references and describes several mounting systems that may be utilized to secure a seating pallet to a floor or other structure in a passenger cabin. Accordingly, U.S. Pat. No. 4,936,527 to F. J. Gorges is hereby incorporated by reference herein in its entirety.

In addition to the features previously described, a seating module 400a, 400b, 400c may further include housing that may be used to contain various passenger service systems such as lighting, air, emergency oxygen. As shown in the embodiment illustrated in FIGS. 10-18, the housing 488 may be located in the space between the aft section of the window seat portion 412 of the privacy screen and the fore section of the aisle seat portion 414 of the privacy screen. As another option, a housing 490, 492 may be provided for each seat of a seating module to provide the passenger service systems for that particular seat. Such an implementation is illustrated in the embodiment shown in FIGS. 4-9. In such an implementation, a housing 490 may be provided for the aisle seat 404 that is located adjacent the head rest of the aisle seat adjacent a corner when the central and aft sections of aisle seat portion of the privacy screen meet. Another housing 492 may be provided for the window seat 408 that is located adjacent the head rest of the window seat adjacent the central section of window seat portion of the privacy screen.

The seating module 400a, 400b, 400c may also include an in-flight entertainment system 494 for each of the seats as shown in the embodiment depicted in FIG. 10-18. The in-flight entertainment systems 494 may be coupled, for example, to corresponding sides of the central section of the window seat portion 412 of the privacy screen.

The seating module 400a, 400b, 400c may also include power outlets and network connections for each seat. These outlets may be provided for example, in one of the housings, the privacy screen, a seat and/or the central keel.

Each seat 404, 408 of a seating module may also having a retractable or stowable meal tray associated therewith. Such a meal tray can be stowed in an armrest of its corresponding seat or in a slot 496 or cavity provided in the central keel (see e.g., in FIGS. 4, 5 and 9). Each seat and/or footstool may have fixtures and apertures 498 for including/mounting seat belts for the respective seat or footstool.

In use, seating modules 400a, 400b, 400c such as the embodiments depicted in FIGS. 4-18 may be arranged in a passenger compartment 100, 200 of an aircraft (or other vehicle)—as shown by the layouts depicted in FIGS. 1 and 2—in one or more rows 08, 110 in a linear arrangement (i.e., a line) in the row with the seating modules spaced apart from the adjacent seating modules. In such an arrangement, the window footstool of a more forwardly located seating module (or “first seating module”) may face the window seat of an adjacent more rearwardly located seating module (or “second seating module”) located directly behind the first seating module so that, together, the window footstool of the first seating module and the window seat of the second seating module define a window passenger section.

While the seating modules are depicted in FIGS. 1 and 2 as being arranged so that their window and aisle seats face the front or nose end of the passenger cabin, it should be understood to one of ordinary skill in the art that the modules can also be arranged in a manner so that the fore ends and the window and aisle seats of the seating modules face in the opposite direction towards the rear or tail end of the passenger cabin.

For purposes of better describing the layout of seating modules, the components of each the seating module may define three sections: a window seat section, a window footstool section, an aisle seat section (or aisle passenger section). The window seat section includes the window seat and the window seat portion of the privacy screen. The window footstool section includes the window footstool and the fore section of the aisle seat portion of the privacy screen. The aisle seat section includes the aisle seat, the aisle footstool and the aft and aisle sections of the aisle seat portion of the privacy screen.

The space between each adjacent pair of seating modules (i.e., each first and second seating module pair) defines a passageway to the window passenger section between the aft section of the aisle portion of the privacy screen of the more forwardly located seating module and the aisle footstool of the more rearwardly located seating module. In this arrangement, when the aisle footstool of the second seating module is positioned in the fore position, a portion of the back portion of the frame can forwardly extend into the passageway (i.e., beyond the fore end of the central keel of the second seating module) and block a portion of the passageway when the aisle footstool is in the fore position. In an exemplary embodiment, the passageway defined between seating modules may be at least 16″ wide to help provide easy access between the window seat section and the central aisle of the passenger cabin.

As shown in the Figures, the seats may be arranged in a staggered double design. In an exemplary embodiment, the staggered double design may stagger adjacent seats at a pitch of about 87″. In such an implementation, the widow seat of a seating module may be staggered approximately 30″ in front of the aisle seat seating module to help afford easy access and sufficient privacy for each passenger seat. In another embodiment, the seats may be staggered approximately 27″. In one embodiment, each seat may be configured to have a 22″ wide by 30″ deep seat bottom (i.e., seat portion) between the armrests with a 22″ wide by 30″ tall seat back. The footstools may be implemented in one embodiment to have dimensions of a 15″ deep by 18″ wide for providing comfortable accommodation to a person setting thereon. In such an exemplary embodiment, to convert a seat from an upright position to a reclined position where the seat may be used as a bed (i.e., a bed mode or configuration), the seat bottom may translates 14″ forward as it reclines from the upright position to the reclined position. In such an implementation, the leg rest may have dimensions of 10″ deep by 18″ wide so that when it is deployed in the extended position, the leg rest can fill the gap between the seat and footstool with the resulting flat bed configuration (including the footstool) having a length of about 75″. In another embodiment, the seat and/or the footstool may be lengthened so that the flat bed configuration is increased to about 78″. In one exemplary embodiment, the aisle footstool may capable of translational movement of about 6″ aft (toward the seat) during loading/unloading to provide a 16″ wide passage to the window seat between two adjacent seating modules. In such an exemplary embodiment, the passageway may be at least 9″ to provide at least some space to permit passage between the window seat section and the central aisle of the passenger cabin.

A common goal of seat design is to produce a seat module that provides an excellent passenger experience. Utilizing the embodiments described herein, a layout of passenger accommodations may be implemented that can provide a spacious and comfortable environment for each passenger that is better than existing airline offerings and is more commensurate with that provided in long range corporate business jets. Additional refinements to the designs of various embodiments described herein may be implemented to create seating modules using shapes and colors that may be more pleasing to a passenger.

While various embodiments have been described, they have been presented by way of example only, and not limitation. Thus, the breadth and scope of any embodiment should not be limited by any of the above described exemplary embodiments, but should be defined only in accordance with the following claims and their equivalents.

What is claimed:

1. A seating module, comprising:
a central keel defining opposite aisle and window side areas and opposite fore and aft ends;
an aisle seat and an aisle footstool located in the aisle side area;
a window seat and a window footstool located in the window side area, the window seat being in a staggered relationship with the aisle seat with the window seat positioned closer towards the fore end than the aisle seat; and
a privacy screen comprising an window seat portion and an aisle seat portion, the window seat portion of the privacy screen extending along the central keel and between the window seat and the window footstool, the aisle seat portion of the privacy screen extending between the window seat and the window footstool between the window seat portion of the privacy screen, the aisle seat portion of the privacy screen further extending along the central keel between the window footstool and the aisle seat, the aisle seat portion of the privacy screen further extending behind the aisle seat and along an aisle side of the aisle seat in a direction towards the fore end.

2. The seating module of claim 1, wherein each seat comprises a reclining seat selectively positionable between an upright position and a reclined position, wherein a back portion of the reclining seat reclines downwards as a seat portion of the reclining seat moves laterally forwards when the reclining seat is moved from the upright position towards the reclined position.

3. The seating module of claim 1, wherein each seat has a retractable leg rest capable of being positioned in an extended position lying in a generally horizontal common plane with a seat portion of the seat.

4. The seating module of claim 1, wherein at least one of the seats has a retractable armrest capable of being selectively retracted downwards.

5. The seating module of claim 1, wherein at least one of the seats has an armrest formed in an upper face of the central keel.

6. The seating module of claim 1, wherein at least one of the seats has an armrest formed in an adjacent region of the privacy screen.

7. The seating module of claim 1, wherein the aisle footstool is capable of traverse movement between the fore and aft ends.

8. The seating module of claim 7, wherein the aisle footstool is traversally movable between fore and aft positions, wherein a portion of the aisle footstool forwardly extends beyond the fore end of the central keel when the aisle footstool is positioned in the fore position.

9. The seating module of claim 1, wherein the aisle footstool has a storage space beneath a seat portion of the aisle footstool.

10. The seating module of claim 9, wherein the seat portion of the aisle footstool being pivotally coupled to the aisle footstool.

11. The seating module of claim 1, further comprising a back pad coupled to the region of the aisle seat portion of the privacy screen located adjacent the window footstool.

12. The seating module of claim 1, further comprising a window footstool armrest positioned adjacent a central keel side of the window footstool.

13. The seating module of claim 12, wherein the window footstool armrest is formed in an aft located region of the central keel located adjacent the window footstool.

14. The seating module of claim 1, wherein the central keel has at least one cup holder.

15. The seating module of claim 1, further comprising mountings for mounting to slotted floor tracks in a passenger cabin.

16. The seating module of claim 1, further comprising at least one housing for containing passenger service systems multi-module arrangement

17. A seating module system, comprising:
a plurality of seating modules, each seating module having an aisle seat located behind an aisle footstool and a window seat located in front of a window footstool, the window seat in a staggered arrangement with the aisle seat with the window seat more forwardly positioned than the aisle seat;
the plurality of seating modules being arranged in at least one row with adjacent seating modules spaced apart from each other;
the window footstool of a first seating module facing the window seat of an adjacent second seating module so that the window footstool of the first seating module and the window seat of the second seating module define a window passenger section.

18. The seating module system of claim 17, wherein the space between the first and second seating modules defines a passageway to the window passenger section, wherein the aisle footstool is selectively movable into the passageway.

19. The seating module system of claim 1, wherein at least one of the seating modules has a privacy screen extending between the window seat, the window footstool and the aisle seat of the seating module.

20. The seating module system of claim 1, wherein the plurality of seating modules are provided in a passenger cabin of an airplane.
